(19) United States
(12) Patent Application Publication
(10) Pub. No.: US 2004/0084446 A1
(43) Pub. Date: May 6, 2004

(54) Microwave oven browning and welding applications

(75) Inventors: Carlo Perego, Dalmine (IT); Zhengyu Hong, Dalmine (IT)

Correspondence Address: Robert E. Walter, GE Plastics, One Plastics Avenue, Pittsfield, MA, 01201, US

(73) Assignee: General Electric Company

(21) Appl. No.: 10/653,124

(22) Filed: Sep. 2, 2003

Related U.S. Application Data
(60) Provisional application No. 60/424,405, filed on Nov. 6, 2002.

(51) Int. Cl. H05B 6/64

(52) U.S. Cl. 219/679

(57) ABSTRACT

A thermoplastic resin article suitable for use in browning of food or browning the surface of food in a microwave oven which article comprises a high heat thermoplastic resin such as a polyetherimide and a ferrite and/or silicon carbide which article can be produced by injection molding. The article may be a plate or other article suitable for browning of food. Also low heat thermoplastic resins such as polyethylene in combination with a ferrite and/or silicone carbide are suitable for microwave welding applications.

### CROSS REFERENCE TO RELATED APPLICATIONS

This application claims priority to U.S. Provisional Application Serial No. 60/424405 filed on Nov. 6, 2002, which is incorporated herein by reference in its entirety.

### FIELD OF INVENTION

This invention is related to a thermoplastic article such as a dish having in combination or containing microwave susceptible materials and which dish is suitable for cooking, baking or heating food, in a microwave oven and for browning of such foods. These materials in combination with particular high heat thermoplastics have a high dielectric loss and can efficiently convert the electromagnetic energy to heat.

### BACKGROUND OF THE INVENTION

Most food cooked in a microwave oven lack the brown surface color achieved during or using conventional methods. Backed foods, for example, do not obtain favorable brown crust and meat usually has a gray surface appearance when prepared n a microwave oven. Many times, to obtain or enhance surface appearance of food cooked in a microwave oven, a browning device is often required.

Various developments have been made in effort to enhance surface appearance of foods cooked in a microwave oven, namely browning, originally browning of meats. One such invention is disclosed in U.S. Pat. No. 4,542,271 wherein an article is formed of a member transparent to microwave energy which article has a sidewall and a base, a metallic part having a heating matrix absorbent to microwave energy which is cured to the lower surface of the metallic pan. The heating matrix comprises a plastic matrix and magnetite particles dispersed in the plastic matrix. The plastic matrix is a blend of three plastics. The three plastics are a polyester resin (thermoset), a styrene monomer and a polyethylene powder or an acrylic emulsion. The polyester resin and styrene are copolymerized during heating. The polyethylene or acrylic emulsion prevents shrinkage because it will expand at polymerization temperatures while polyester resin contracts. The use of all three plastics appears to be critical to the invention. U.S. Pat. No. 4,454,403 discloses a heating apparatus which also employs a heat conductive layer to which is bonded a layer of glossy material. The latter is dispersed as a ferrite in a high temperature plastic such as silicone.

### SUMMARY OF INVENTION

Microwave ovens have been used for preparing or heating foods for sometime. One general problem, however, with microwave ovens is the difficulty in obtaining browning of food or a browned surface on food which is obtained in a general gas or electric oven other than a microwave oven. Proposal for the solution of such in prior art involved making a microwave oven dish that was composed of ferrite materials, either by sintering or mixing with silicone rubber.

The instant invention is directed to compositions of particular thermoplastic materials which when molded into an article such as dishes, etc. can be used for browning of food in microwave ovens. In the practice of this invention, ferrite and/or silicon carbide can be mixed in the form of powders with high heat resistant thermoplastic resins such as polyetherimide or polysulphone and compounded in an extruder or the like.

### BRIEF DESCRIPTION OF THE DRAWINGS

FIG. 1 is a bar chart showing microwave radiation with respect to formulation vs. power.

FIG. 2 is a graph showing thermoplastic composites subjected to microwave heating at 300 watts.

FIG. 3 is a graph showing thermoplastic composites subjected to microwave heating at 600 watts.

### DETAILED DESCRIPTION OF THE INVENTION

This invention is directed to a microwaveable thermoplastic composite which can be used as a browning dish for microwave oven cooking or thermoplastic parts for microwave welding applications. The thermoplastic composites comprise in combination a high heat resistant thermoplastic resin and a ferrite or a silicone carbide or a mixture of a ferrite and silicon carbide which are preferably in powder form. The ferrite may be any of the known ferrites and may include, but not limited there to, such ferrites as lithium ferrite, copper ferrite, magnesium ferrite, strontium ferrite, magnesium manganese ferrite, magnesium manganese zinc ferrite, iron manganese zinc ferrite, ferrous ferrite, and the like. The thermoplastic resins can include, but not limited thereto, such high heat resistant resins as polyetherimide (PEI), polyphenylene sulfide (PSS), polyamide (PA), polyphenylene ether (PPE), aliphatic polyketone (PK), polyetheretherketones (PEEK), polysufones (PPU), and the like. In the event higher surface temperature is required, higher heat resistant resins can be employed such as polyphenylenesulfides. By incorporating silicon carbide with the thermoplastic resin and ferrite makes the composite microwave sensitive and improves the heat transfer between the composite article and the food being cooked or heated. Therefore, this makes the system more efficient.

Experimental results show that thermoplastic composites containing ferrite and/or silicon carbide can be heated effectively in a microwave oven to above 200° C. The efficiency and the surface temperature vary with the filler type, filer loading and microwave power. The composite composition can be designed for or tailored to a specific application. For example, if a temperature of 200° C. is required and needs to be controlled for a microwave baking application, a molded thermoplastic composite part consisting of a polyetherimide and 50 wt % of a ferrite can be used with a setting of 300 watts microwave power

The composite composition of the instant invention offers advantages of being easily processed and injection molded to a desired shape compound to the prior art. In light of the food browning application in microwave ovens, the thermoplastic molded article herein described may also comprise the composition for microwave welding applications as well. However, for the microwave welding applications, the high heat thermoplastic resin is not required. Any thermoplastic resin may be so employed such as, but not limited thereto, polyethylene (PE), polypropylene (PP), polystyrene (PS), polyamide (PA), polycarbonate (PC), blends thereof and blends with other polymers, and the like.

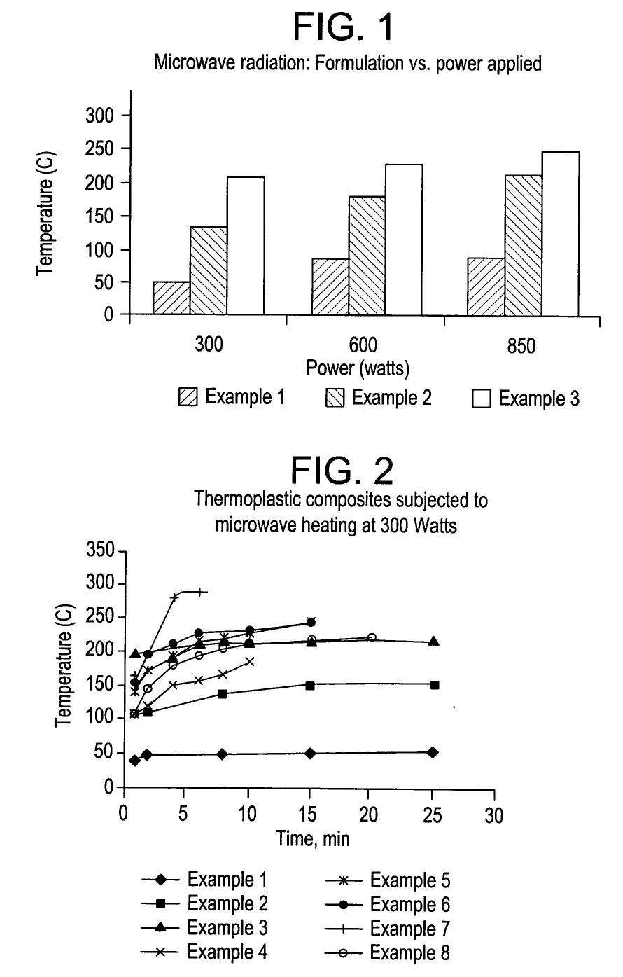

Referring to FIG. 1, the bar graph shows the temperature reached for formulations 1, 2, and 3 of the examples which are formulations of the instant invention. As shown higher temperatures are reached with the formulations of the Examples at various power (watts) with respect to the high heat resin alone. Thus, as stated above, formulations of thermoplastic with ferrites and/or silicon carbide can be effectively heated with microwave radiation. The bar graph shows compositions of example 2 and 3 have been hated to about 180° C. and about 210° C. respectively at 600 and 850 watts.

FIG. 2 is a graph of the temperature attained upon heating the compositions of this invention namely example 2-8 wherein the temperatures reached were considerably higher at a power of 300 watts vs. Example 1 which contains no filler. The temperatures reached a plateau at the given microwave power with time.

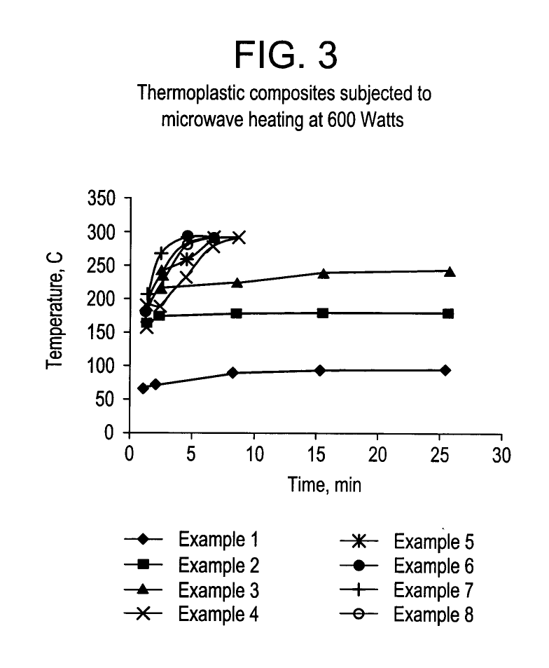

FIG. 3 is a graph of the temperature attained at microwave heating of 600 watts. The temperature for each compositions reaches a plateau with time. Please note, again, that considerably higher temperatures are reached wit the compositions of this invention, namely examples 2-8.

### EXAMPLES

The following table tabulated the formulations of the examples set forth in this invention. The compositions shown are in weight % (wt. %). As shown in the graphs, the results demonstrated that particular high heat resistant thermoplastics resins filled with a ferrite and/or silicone carbide powder can be effectively heated with microwave radiation. The temperature of the composites increases with the increase of the filler loading and increases with the power of the microwave applied. For a fixed compositions, the temperature seems to reach a plateau at a given microwave power with time. Thus, through optimization of the formulation based on filler type, content and base resin, a wide range of desired application temperature requirements can be achieved.

TABLE 1

| | Example | | | | | | | |
|---|---|---|---|---|---|---|---|---|
| Composition (wt %) | 1 | 2 | 3 | 4 | 5 | 6 | 7 | 8 |
| PEI (polyether imide) | 10 | 7 | 5 | | | 51.5 | 36.5 | 5 |
| | 0 | 5 | 0 | | | | | 0 |
| PPS (polyphenyl sulfide) | | | | 55.2 | 41.2 | | | |
| Ferrite (magnesium | | 2 | 5 | | | 48.5 | 63.5 | 4 |
| manganese zinc) | | 5 | 0 | | | | | 0 |
| Silicon carbide | | | | 44.8 | 58.8 | | | 1 |
| | | | | | | | | 0 |

Although the present invention has been fully described in connection with the preferred embodiments thereof with reference to the specification and drawings, it is to be noted that various changes and modifications are apparent to those skilled in the art. Such changes and modifications are to be understood as included with in the scope of the present invention as defined by the appended claims.

What is claimed:

1. A thermoplastic resin article suitable for use in browning food including browning of the surface of food in a microwave oven which article comprises in combination a high heat thermoplastic resin and an additive selected from the group consisting of ferrites, silicone carbide and mixtures thereof, said additive being essentially uniformly dispersed through the article.

2. The thermoplastic article of claim 1 wherein the article is injection molded.

3. The article of claim 1 wherein the article is a plate.

4. The thermoplastics resin of claim 1 wherein said thermoplastic resin is a polyetherimide.

5. The thermoplastic resin of claim 1 wherein the thermoplastic resin a is a polyphenylenesulfide.

6. The thermoplastic article of claim 1 wherein the ferrite is selected from the group consisting of lithium ferrite, copper ferrite, magnesium ferrite, strontium ferrite, magnesium manganese ferrite, magnesium manganese zinc ferrite, iron manganese zinc ferrite, ferrous ferrite and the like.

7. The thermoplastics article of claim 6 wherein the ferrite is lithium ferrite.

8. A thermoplastic composition suitable for microwave welding applications where in the thermoplastic composition comprises (1) a thermoplastic resin selected from the group consisting of polyethylene, polypropylene, polystyrene, polyamide, polycarbonate, blends thereof and blends with other polymers and (2) an additive selected from the group consisting of a ferrite, silicon carbide and mixtures thereof said additive being essentially uniformly dispersed through out the composition.
